(19) United States
(12) Patent Application Publication
(10) Pub. No.: US 2024/0162569 A1
(43) Pub. Date: May 16, 2024

(54) LITHIUM-ION SECONDARY BATTERY

(71) Applicant: TOYOTA JIDOSHA KABUSHIKI KAISHA, Toyota-shi (JP)

(72) Inventor: Masato KAMIYA, Toyota-shi (JP)

(73) Assignee: TOYOTA JIDOSHA KABUSHIKI KAISHA, Toyota-shi (JP)

(21) Appl. No.: 18/385,971

(22) Filed: Nov. 1, 2023

(30) Foreign Application Priority Data
Nov. 16, 2022 (JP) 2022-183396

(51) Int. Cl. H01M 50/46; H01M 10/0525

(52) U.S. Cl. CPC H01M 50/46; H01M 10/0525

(57) ABSTRACT

A lithium-ion secondary battery includes: an electrode body in which a positive electrode having a positive electrode active material layer and a positive electrode current collector, and a negative electrode having a negative electrode active material layer and a negative electrode current collector, are laminated with a separator therebetween, the separator having a conductive layer, wherein: the positive electrode active material layer and the negative electrode active material layer contact the separator, at least one of the positive electrode active material layer or the negative electrode active material layer has a groove in a thickness direction, and a surface of the separator, which faces a surface of the at least one of the positive electrode active material layer or the negative electrode active material layer which has the groove, includes the conductive layer.

### CROSS-REFERENCE TO RELATED APPLICATION

This application is based on and claims priority under 35 USC 119 from Japanese Patent Application No. 2022-183396 filed on Nov. 16, 2022, the disclosure of which is incorporated by reference herein.

### BACKGROUND

### Technical Field

The present disclosure relates to a lithium-ion secondary battery.

### Related Art

Since lithium-ion secondary batteries are lightweight and have high energy density, lithium-ion secondary batteries have been widely used as portable power supplies in, for example, personal computers and portable terminals, and power supplies for driving vehicles such as electric vehicles (EV), hybrid vehicles (HV), and plug-in hybrid vehicles (PHV).

For example, Japanese Patent No. 5640546 proposes “A separator for use in a non-aqueous electrolyte secondary battery, including a positive electrode and a negative electrode which are capable of occluding and releasing lithium, a separator, and a non-aqueous electrolytic solution including an electrolyte dissolved in a non-aqueous solvent, wherein the separator has a conductive layer containing a conductive material and a binder, an apparent volume resistivity of the conductive layer is from 1×10⁻⁴ Ω·cm to 1×10⁶ Ω·cm, and a film thickness of the conductive layer is less than 5 and a non-aqueous electrolyte secondary battery including the separator.”

In lithium-ion secondary batteries, in a case in which at least one of the positive electrode active material layer or the negative electrode active material layer contains a metal impurity, an internal short circuit may occur. Therefore, it is preferable that the presence or absence of metal impurities be easily determined. Here, as the determination of the presence or absence of a metal impurity, a method called an insulation inspection test or a spike leakage test, for example, is used.

In lithium secondary batteries, in some cases, a groove is formed in at least one of the positive electrode active material layer or the negative electrode active material layer so that the non-aqueous electrolyte quickly penetrates the electrode body. In these cases, in lithium-ion secondary batteries having a groove in at least one of the positive electrode active material layer or the negative electrode active material layer, when metal impurities are present in the groove, it may be difficult to determine whether or not metal impurities are present using an insulation inspection test. This is because the contact area between the metal impurity and the electrode becomes small.

### SUMMARY

The problem to be solved by the present disclosure is to provide a lithium-ion secondary battery having a groove in at least one of a positive electrode active material layer or a negative electrode active material layer, for which it is easy to determine, using an insulation inspection test, the presence or absence of metal impurities.

Means for solving the foregoing problem include the following embodiments.
<1> A lithium-ion secondary battery including: an electrode body in which a positive electrode having a positive electrode active material layer and a positive electrode current collector, and a negative electrode having a negative electrode active material layer and a negative electrode current collector, are laminated with a separator therebetween, the separator having a conductive layer, wherein: the positive electrode active material layer and the negative electrode active material layer contact the separator, at least one of the positive electrode active material layer or the negative electrode active material layer has a groove in a thickness direction, and a surface of the separator, which faces a surface of the at least one of the positive electrode active material layer or the negative electrode active material layer which has the groove, includes the conductive layer.
<2> The lithium-ion secondary battery according to <1>, wherein the positive electrode active material layer has the groove.
<3> The lithium-ion secondary battery according to <1> or <2>, wherein the separator has the conductive layer only at a portion facing the groove.

According to the present disclosure, there is provided a lithium-ion secondary battery having a groove in at least one of a positive electrode active material layer or a negative electrode active material layer, for which it is easy to determine, using an insulation inspection test, the presence or absence of metal impurities.

### BRIEF DESCRIPTION OF THE DRAWINGS

Exemplary embodiments of the present disclosure will be described in detail based on the following figures, wherein:

FIG. 1 is a schematic front view illustrating a cross section of an electrode body, in a thickness direction, according to an exemplary embodiment; and

FIG. 2 is a schematic front view illustrating a cross section of an electrode body, in a thickness direction, according to another exemplary embodiment.

### DETAILED DESCRIPTION

Hereinafter, exemplary embodiments, which are examples of the present disclosure, will be described. These descriptions and examples are intended to illustrate exemplary embodiments and do not limit the scope of the present disclosure.

In numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. Further, in the numerical ranges described in the present disclosure, the upper limit value or the lower limit value described in a given numerical range may be replaced with a value shown in the examples.

Each component in the present disclosure may contain plural substances of interest.

In the present disclosure, when referring to the amount of each component in a composition, in a case in which there are plural types of substances that correspond to each component in the composition, unless otherwise specified, the amount of each component means the total amount of plural types of substances in the component.

In the present disclosure, the term “step” includes not only an independent step, but also a step that cannot be clearly distinguished from another step as long as the intended operation of the step is achieved.

Lithium-Ion Secondary Battery

A lithium-ion secondary battery (hereinafter, simply referred to as a “secondary battery”) according to the present disclosure includes an electrode body in which a positive electrode having a positive electrode active material layer and a positive electrode current collector, and a negative electrode having a negative electrode active material layer and a negative electrode current collector, are laminated with a separator therebetween, the separator having a conductive layer, wherein the positive electrode active material layer and the negative electrode active material layer contact the separator, at least one of the positive electrode active material layer or the negative electrode active material layer has a groove in the thickness direction, and a surface of the separator, which faces a surface of the at least one of the positive electrode active material layer or the negative electrode active material layer which has the groove, includes the conductive layer.

In the secondary battery according to the present disclosure, due to the above configuration, it is easy to determine, using an insulation inspection test, whether or not there metal impurities are included. The reason for this is presumed as follows.

The separator included in the secondary battery according to the present disclosure has a conductive layer on a surface of the separator, which faces a surface of the at least one of the positive electrode active material layer or the negative electrode active material layer which has the groove. Therefore, even in a case in which metal impurities are contained in the groove, the conductive layer and the metal impurities can easily contact each other, whereby it becomes easier to determine whether or not there are metal impurities when performing an insulation inspection test.

Hereinafter, the secondary battery according to the present disclosure will be described in detail.

Electrode Body

In the electrode body, a positive electrode having a positive electrode active material layer and a positive electrode current collector, and a negative electrode having a negative electrode active material layer and a negative electrode current collector, are laminated with a separator therebetween, the separator having a conductive layer. Further, the positive electrode active material layer and the negative electrode active material layer contact the separator.

Specifically, the electrode body has a layer structure of a positive electrode current collector/a positive electrode active material layer/a separator/a negative electrode active material layer/a negative electrode current collector. Here, note that “/” represents an interface between layers.

Here, in the electrode body, both the positive electrode active material layer and the negative electrode active material layer may have a groove.

In this case, the separator preferably has a conductive layer on both the surface facing the surface of the positive electrode active material layer and the surface facing the surface of the negative electrode active material layer (that is, both surfaces of the separator).

Positive Electrode

The positive electrode has a positive electrode active material layer and a positive electrode current collector.

Examples of the positive electrode current collector include aluminum foil.

The positive electrode active material layer contains a positive electrode active material. Examples of the positive electrode active material include lithium transition metal oxides (for example, LiNi_{1/3}Co_{1/3}Mn_{1/3}O₂, LiNiO₂, LiCoO₂, LiFeO₂, LiMn₂O₄, and LiNi_{0.5}Mn_{1.5}O₄), and lithium transition metal phosphate compounds (for example, LiFePO₄).

The positive electrode active material layer can contain, for example, a conductive additive and a binder in addition to the positive electrode active material. As the conductive additive, a carbon black such as acetylene black (AB) or other carbon materials (for example, graphite) can be suitably used. As the binder, for example, polyvinylidene fluoride (PVdF) or the like can be used.

The thickness of the positive electrode active material layer is not particularly limited, and is preferably greater than or equal to 50 μm and less than or equal to 250 μm, more preferably greater than or equal to 100 μm and less than or equal to 200 μm, and still more preferably greater than or equal to 130 μm and less than or equal to 170 μm.

From the viewpoint of ease of determination of the presence or absence of metal impurities, the positive electrode active material layer preferably has a groove.

The depth of the groove is not particularly limited, but is preferably the same as the thickness of the positive electrode active material layer.

The width of the groove is not particularly limited, but is preferably greater than or equal to 0.5 mm and less than or equal to 5 mm, more preferably greater than or equal to 1 mm and less than or equal to 3 mm, and still more preferably greater than or equal to 2 mm and less than or equal to 3 mm.

The shape of the groove is not particularly limited, and may be linear or curved, but is preferably linear.

It is preferable that the positive electrode active material layer has plural linear grooves at regular intervals, and that the grooves do not intersect with each other.

In a case in which the positive electrode active material layer has plural linear grooves, the gap between the grooves is preferably greater than or equal to 50 mm and less than or equal to 200 mm, more preferably greater than or equal to 70 mm and less than or equal to 150 mm, and still more preferably greater than or equal to 80 mm and less than or equal to 120 mm.

Here, the gap between the grooves means the shortest distance between two adjacent grooves.

Negative Electrode

The negative electrode has a negative electrode active material layer and a negative electrode current collector.

Examples of the negative electrode current collector include copper foil.

The negative electrode active material layer contains a negative electrode active material. Examples of the negative electrode active material include graphite-based carbon materials, lithium titanate (Li₄Ti₅O₁₂:LTO), Sn, and Si-based materials.

The negative electrode active material layer can contain, for example, a binder and a thickener in addition to the negative electrode active material. As the binder, for example, styrene-butadiene rubber (SBR) or the like can be used. As the thickener, for example, carboxymethyl cellulose (CMC) can be used.

The thickness of the negative electrode active material layer is not particularly limited, and is preferably greater than or equal to 50 μm and less than or equal to 250 μm, more preferably greater than or equal to 100 μm and less than or equal to 200 μm, and still more preferably greater than or equal to 130 μm and less than or equal to 170 μm.

From the viewpoint of ease of determination of the presence or absence of metal impurities, in a case in which the positive electrode active material layer does not have a groove, the negative electrode active material layer preferably has a groove.

Here, the preferred embodiment of the groove included in the negative electrode active material layer is the same as the groove included in the positive electrode active material layer described above.

Separator

The separator has a conductive layer. The conductive layer is provided on the surface of the separator which faces at least one of the positive electrode active material layer or the negative electrode active material layer which has a groove.

The conductive layer preferably contains a conductive material and a binder.

Examples of the conductive material include a metal and a carbon material.

Examples of the metal include elemental metals such as aluminum, tungsten, molybdenum, titanium, tantalum, copper, nickel, iron, and chromium; and alloys such as stainless steel.

Examples of the carbon material include graphite, carbon black, needle coke, and carbon nanotubes.

The binder is not particularly limited, and for example, polyvinylidene fluoride (PVdF) can be used.

In the conductive layer, the content of the conductive material in the binder is preferably greater than or equal to 10% by mass and less than or equal to 50% by mass, more preferably greater than or equal to 20% by mass and less than or equal to 40% by mass, and still more preferably greater than or equal to 25% by mass and less than or equal to 35% by mass.

The thickness of the conductive layer is preferably greater than or equal to 1 μm and less than or equal to 10 μm, more preferably greater than or equal to 2 μm and less than or equal to 7 μm, and still more preferably greater than or equal to 3 μm and less than or equal to 5 μm.

From the viewpoint of ease of determination of the presence or absence of metal impurities, the separator preferably has a conductive layer only at the portion facing the groove that is included in the positive electrode active material layer or the negative electrode active material layer.

The separator preferably has a conductive layer on the surface of a porous sheet (film) composed of a resin such as polyethylene (PE), polypropylene (PP), polyester, cellulose, or polyamide.

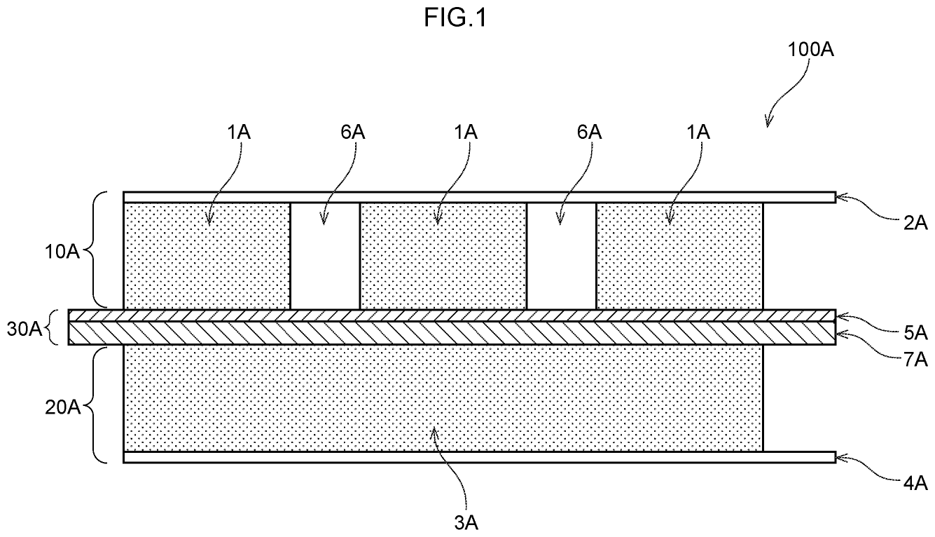

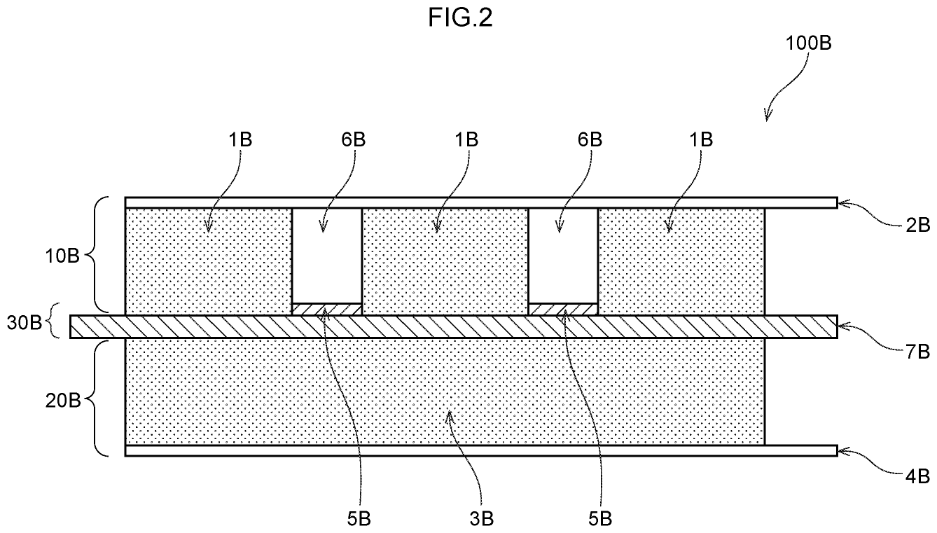

Hereinafter, embodiments of the electrode body will be described with reference to FIG. 1 and FIG. 2. Note that FIG. 1 and FIG. 2 are merely examples of electrode bodies, and the present disclosure is not limited thereto.

FIG. 1 is a schematic front view illustrating a cross section of an electrode body, in a thickness direction, according to an exemplary embodiment.

In the electrode body 100A, as illustrated in FIG. 1, a positive electrode 10A having a positive electrode active material layer 1A and a positive electrode current collector 2A, and a negative electrode 20A having a negative electrode active material layer 3A and a negative electrode current collector 4A are laminated with a separator 30A therebetween, the separator 30A including a conductive layer 5A. The separator 30A includes a porous sheet 7A.

In the electrode body 100A illustrated in FIG. 1, the positive electrode active material layer 1A has grooves 6A in the thickness direction of the positive electrode active material layer 1A. Further, the conductive layer 5A is arranged at the surface of the separator 30A on the positive electrode active material layer 1A side, which has the grooves 6A. Here, the grooves 6A extend linearly in the observation direction in the schematic front view.

FIG. 2 is a schematic front view illustrating a cross section of an electrode body, in a thickness direction, according to another exemplary embodiment.

In the electrode body 100B, as illustrated in FIG. 2, a positive electrode 10B having a positive electrode active material layer 1B and a positive electrode current collector 2B, and a negative electrode 20B having a negative electrode active material layer 3B and a negative electrode current collector 4B are laminated with a separator 30B therebetween, the separator 30B having a conductive layer 5B. The separator 30B includes a porous sheet 7B.

In the electrode body 100B illustrated in FIG. 2, the positive electrode active material layer 1B has grooves 6B in the thickness direction of the positive electrode active material layer 1B. Further, in the conductive layer 5B, only portions where the conductive layer 5B faces the grooves are arranged at the surface of the separator 30B on the positive electrode active material layer 1B side, which has the grooves 6B. Here, the grooves 6B extend linearly in the observation direction in the schematic front view.

Non-Aqueous Electrolyte

The secondary battery according to the present disclosure preferably contains a non-aqueous electrolyte.

The non-aqueous electrolyte is not particularly limited, and conventionally known non-aqueous electrolytes can be used.

The non-aqueous electrolyte preferably contains a non-aqueous solvent and a supporting salt. Examples of the non-aqueous solvent include carbonates such as ethylene carbonate, diethyl carbonate, dimethyl carbonate, and ethyl methyl carbonate, and ethers and esters. Examples of the supporting salt include lithium salts such as LiPF₆ and LiBF₄.

Method for Manufacturing the Secondary Battery

The secondary battery according to the present disclosure is preferably manufactured by preparing a separator having a positive electrode, a negative electrode, and a conductive layer, laminating them to obtain an electrode body, and then housing the electrode body in a battery case (an outer container).

Preferably, the positive electrode and the negative electrode are prepared by coating a slurry containing an active material (that is, a positive electrode active material or a negative electrode active material) and a solvent on a current collector (that is, a positive electrode current collector or a negative electrode current collector) and drying the current collector.

Examples of the method of forming a groove in the positive electrode active material layer or the negative electrode active material layer include a method of forming a groove by partially scraping the positive electrode active material layer or the negative electrode active material layer which is obtained by applying and drying the aforementioned slurry on a current collector.

It is preferable to prepare a separator having a conductive layer by applying a slurry containing a conductive material, a binder, and a solvent to the surface of the above-described porous sheet and drying the slurry.

### EXAMPLES

Although examples are described below, the present disclosure is not limited to these examples in any way. Note that in the following descriptions, unless otherwise specified, “parts” and “%” are all based on mass.

Preparation of Positive Electrode

A positive electrode 1 and a positive electrode 2 were prepared by the following procedure.

Positive Electrode 1

A positive electrode active material (LiNi_{1/3}Co_{1/3}Mn_{1/3}O₂):a conductive additive (acetylene black):a binder (PVdF) were mixed at a ratio of 91:4:4 (mass ratio) in N-methyl-2-pyrrolidone as a solvent to prepare a slurry for forming a positive electrode active material layer, which was applied to an aluminum foil and dried. Then, by using a laser to remove the positive electrode active material layer after coating, a positive electrode 1 having plural linear positive electrode active material layers having a width of 100 mm and a thickness of 150 μm at intervals of 2 mm was obtained. The linear positive electrode active material layers did not intersect with each other, and were parallel to each other.

Positive Electrode 2

The slurry for forming a positive electrode active material layer, which was prepared for the positive electrode 1, was applied to an aluminum foil and dried to obtain a positive electrode 2.

Preparation of Negative Electrode

A negative electrode 1 and a negative electrode 2 were prepared by the following procedure.

Negative Electrode 1

A negative electrode active material (natural graphite):a binder (styrene-butadiene rubber (SBR)):a thickener (carboxymethyl cellulose (CMC)) were mixed at a ratio of 91:4:4 ratio (mass ratio) in water as a solvent to prepare a slurry for forming a negative electrode active material layer, which was applied to a copper foil and dried to obtain negative electrode 1.

Negative Electrode 2

The slurry for forming a negative electrode active material layer, which was prepared for the negative electrode 1, was applied to a copper foil and dried. Then, by using a laser to remove the negative electrode active material layer after coating, a negative electrode 2 having plural linear negative electrode active material layers having a width of 100 mm and a thickness of 150 μm at intervals of 2 mm was obtained. The linear negative electrode active material layers did not intersect with each other, and were parallel to each other.

Preparation of Separator

A separator 1, a separator 2, and a separator 3 were prepared by the following procedure.

Separator 1

A slurry for forming a conductive layer containing polyvinylidene fluoride as a binder, carbon black (acetylene black) as a conductive material, and N-methyl-2-pyrrolidone as a solvent was prepared. Note that the content of the conductive material with respect to the binder in the slurry for forming a conductive layer was 30% by mass.

The slurry for forming a conductive layer was coated on one surface of a porous sheet (a porous sheet composed of a polyethylene resin), and dried to obtain a separator having a conductive layer having a thickness of 4 μm.

Separator 2

The slurry for forming a conductive layer, which was prepared for separator 1, was coated on one surface of the same porous sheet as that which was used in separator 1, with masking tape (made of polyimide) being applied to the porous sheet in advance, and dried. Thereafter, the masking tape was peeled off to obtain a separator having plural linear conductive layers having a width of 2 mm and a thickness of 4 μm at intervals of 100 mm. The linear conductive layers did not intersect with each other, and were parallel to each other.

Separator 3

The same porous sheet as that which was used for separator 1 was prepared as separator 3.

### Example 1

An electrode body was obtained by laminating the positive electrode 1 and the negative electrode 1 with the separator 1 therebetween. At this time, the positive electrode active material layer and the negative electrode active material layer were brought into contact with the separator 1, and the conductive layer of the separator 1 was made to face the positive electrode 1 side (that is, the state illustrated in FIG. 1). Furthermore, as a metal impurity, one stainless steel ball having a diameter of 200 μm was arranged in the groove of the positive electrode active material layer of the positive electrode 1.

The electrode body prepared by the above procedure was housed in a battery case to thereby produce a secondary battery. Incidentally, five secondary batteries of each example were prepared by the same procedure.

### Example 2

An electrode body was obtained by laminating the positive electrode 1 and the negative electrode 1 with the separator 2 therebetween. At this time, the positive electrode active material layer and the negative electrode active material layer were brought into contact with the separator 2, and the conductive layer of the separator 2 was made to face the positive electrode 1 side, and the separator 2 was configured to include a conductive layer only at the portion facing the groove of the positive electrode active material layer (that is, the state illustrated in FIG. 2). Furthermore, as a metal impurity, one stainless steel ball having a diameter of 200 μm was arranged in the groove of the positive electrode active material layer of the positive electrode 1.

The electrode body prepared by the above procedure was housed in a battery case to thereby produce a secondary battery.

### Example 3

An electrode body was obtained by laminating the positive electrode 2 and the negative electrode 2 with the separator 1 therebetween. At this time, the positive electrode active material layer and the negative electrode active material layer were brought into contact with the separator 1, and the conductive layer of the separator 1 was made to face the negative electrode 2 side (that is, in FIG. 1, the state in which 1A is a negative electrode active material layer, 2A is a negative electrode current collector, 3A is a positive electrode active material layer, and 4A is a positive electrode current collector). Furthermore, as a metal impurity, one stainless steel ball having a diameter of 200 μm was arranged in the groove of the negative electrode active material layer of the negative electrode 2.

The electrode body prepared by the above procedure was housed in a battery case to thereby produce a secondary battery.

### Example 4

An electrode body was obtained by laminating the positive electrode 2 and the negative electrode 2 with the separator 2 therebetween. At this time, the positive electrode active material layer and the negative electrode active material layer were brought into contact the separator 2, and the conductive layer of the separator 2 was made to face the negative electrode 2 side, and the separator 2 was configured to include a conductive layer only at the portion facing the groove of the negative electrode active material layer (that is, in FIG. 2, the state in which 1B is a negative electrode active material layer, 2B is a negative electrode current collector, 3B is a positive electrode active material layer, and 4B is a positive electrode current collector). Furthermore, as a metal impurity, one stainless steel ball having a diameter of 200 μm was arranged in the groove of the negative electrode active material layer of the negative electrode 2.

The electrode body prepared by the above procedure was housed in a battery case to thereby produce a secondary battery.

### Comparative Example 1

An electrode body was obtained by laminating the positive electrode 1 and the negative electrode 1 with the separator 3 therebetween. At this time, the positive electrode active material layer and the negative electrode active material layer were brought into contact with the separator 3. Furthermore, as a metal impurity, one stainless steel ball having a diameter of 200 μm was arranged in the groove of the positive electrode active material layer of the positive electrode 1.

The electrode body prepared by the above procedure was housed in a battery case to thereby produce a secondary battery.

### Comparative Example 2

An electrode body was obtained by laminating the positive electrode 2 and the negative electrode 2 with the separator 3 therebetween. At this time, the positive electrode active material layer and the negative electrode active material layer were brought into contact with the separator 3. Furthermore, as a metal impurity, one stainless steel ball having a diameter of 200 μm was arranged in the groove of the negative electrode active material layer of the negative electrode 2.

The electrode body prepared by the above procedure was housed in a battery case to thereby produce a secondary battery.

Insulation Inspection Test (Spike Leakage) Test

The secondary battery obtained in each example was subjected to a spike leakage test. Specifically, in a room temperature (25° C.) environment, a load of 6 kN was applied to the secondary battery in the thickness direction of the battery case, and a spike voltage of 1000 V was applied between the positive and negative external terminals for 10 seconds, whereby the value of the leakage current (dielectric breakdown current) was confirmed. In a case in which the leakage current was 10 mA or greater, it was determined that the secondary battery contained metal impurities. Then, among the five cells prepared in each example, in a case in which it was determined that the battery was a secondary battery containing three or more metal impurities, this was considered a “pass”, and in a case in which it was determined that the battery was a secondary battery containing two or less metal impurities, this was considered a “fail”.

TABLE 1-1

| | Positive Electrode | | Negative Electrode | |
|---|---|---|---|---|
| | | Presence | | Presence |
| | | of Groove | | of Groove |
| | | in Positive | | in Negative |
| | Type of | Electrode | Type of | Electrode |
| | Positive | Active Material | Negative | Active Material |
| | Electrode | Layer | Electrode | Layer |
| Example 1 | 1 | yes | 1 | no |
| Example 2 | 1 | yes | 1 | no |
| Example 3 | 2 | no | 2 | yes |
| Example 4 | 2 | no | 2 | yes |
| Comparative | 1 | yes | 1 | no |
| Example 1 | | | | |
| Comparative | 2 | no | 2 | yes |
| Example 2 | | | | |

TABLE 1-2

| | Separator | | | Insulation Inspection | |
|---|---|---|---|---|---|
| | Type of | Orientation of | Embodiment | Test Result | |
| | Sepa- | Conductive | of Conductive | Detected | Pass/ |
| | rator | Layer | Layer | Number | Fail |
| Example 1 | 1 | positive | entire surface | 5 | pass |
| | | electrode | | | |
| | | side | | | |
| Example 2 | 2 | positive | only at portion | 5 | pass |
| | | electrode | facing the | | |
| | | side | groove | | |
| Example 3 | 1 | negative | entire surface | 4 | pass |
| | | electrode | | | |
| | | side | | | |
| Example 4 | 2 | negative | only at portion | 4 | pass |
| | | electrode | facing the | | |
| | | side | groove | | |
| Com- | 3 | — | none | 0 | fail |
| parative | | | | | |
| Example 1 | | | | | |
| Com- | 3 | — | none | 2 | fail |
| parative | | | | | |
| Example 2 | | | | | |

In Table 1-2, the reason why the item of “Orientation of Conductive Layer” is indicated as “-” in Comparative Example 1 and Comparative Example 2 is that the separator does not have a conductive layer.

In Table 1-2, “entire surface” in “Embodiment of Conductive Layer” means that the entire surface of the positive electrode side or the negative electrode side of the separator has the conductive layer thereon, and “only at portion facing the groove” means that among the surface on the positive electrode side or the negative electrode side, only the portion facing the groove of the positive electrode active material layer or the negative electrode active material layer has the conductive layer.

In Table 1-2, “Detected Number” described in the column below “Insulation Inspection Test Result” indicates the number of batteries that were determined to be secondary batteries containing metal impurities.

From the above results, it can be seen that in the secondary battery of the present exemplary embodiments, in a lithium-ion secondary battery having a groove in at least one of the positive electrode active material layer or the negative electrode active material layer, it is easy to determine, using an insulation inspection test, whether or not metal impurities are included.

What is claimed is:

1. A lithium-ion secondary battery comprising:
an electrode body in which a positive electrode having a positive electrode active material layer and a positive electrode current collector, and a negative electrode having a negative electrode active material layer and a negative electrode current collector, are laminated with a separator therebetween, the separator having a conductive layer, wherein:
the positive electrode active material layer and the negative electrode active material layer contact the separator,
at least one of the positive electrode active material layer or the negative electrode active material layer has a groove in a thickness direction, and
a surface of the separator, which faces a surface of the at least one of the positive electrode active material layer or the negative electrode active material layer which has the groove, includes the conductive layer.

2. The lithium-ion secondary battery according to claim 1, wherein the positive electrode active material layer has the groove.

3. The lithium-ion secondary battery according to claim 1, wherein the separator has the conductive layer only at a portion facing the groove.
